(19) United States
(12) Patent Application Publication
(10) Pub. No.: US 2021/0255359 A1
(43) Pub. Date: Aug. 19, 2021

(54) Method for estimating rock brittleness from well-log data

(71) Applicants: Manzar Fawad, Oslo (NO); MD Nazmul Haque Mondol, Oslo (NO)

(72) Inventors: Manzar Fawad, Oslo (NO); MD Nazmul Haque Mondol, Oslo (NO)

(21) Appl. No.: 17/175,770

(22) Filed: Feb. 15, 2021

Related U.S. Application Data
(60) Provisional application No. 62/978,349, filed on Feb. 19, 2020.

(51) Int. Cl. G01V 11/00; G01V 3/20; G01V 1/50; E21B 49/00

(52) U.S. Cl. CPC G01V 11/00; G01V 3/20; G01V 1/50; G01V 2210/6224; G01V 2210/1299; G01V 2210/1429; G01V 2210/6169; E21B 49/00

(57) ABSTRACT

The invention describes a procedure for determining the shale brittleness index from data obtained in the well by at least three well-logging tools measuring corresponding parameters. Three tools, namely sonic, density and deep resistivity, are selected. The time interval signals from the sonic tool are converted to the P-wave velocity. The product of signals obtained from the sonic and density tools (P-wave velocity×Bulk density=Acoustic impedance (AI)) responds in the same direction to a variation of the volume of water and organic matter (OM) volume of the rocks, whereas the third tool (Deep Resistivity) reacts very differently in response to a change of one or other of these same components, in a three-pole diagram, with rock matrix, OM and water as the three components onto an Acoustic Impedance vs resistivity ratio function plane. The resistivity ratio function is the square root of the ratio between the water resistivity and the measured formation resistivity. The position of the curved matrix-water line with OM=0 fraction by volume is fixed connecting the rock matrix point with that of the water point. The slope of the matrix-water curve is controlled by the tortuosity factor ‘a’ that is selected for a formation zone considering the pore structure, grain size and level of compaction. The data points to be analysed can be calibrated accordingly by iterating the resistivity of water (Rw) and occasionally the tortuosity factor (a) parameter to obtain the Rw value. In a graph where the parameters used depend, for example, on the sonic velocity in the rock, the rock bulk density and on the electric resistivity of the formations, the iso quartz/calcite-content lines are denoted as iso-brittleness line as with an increase in quartz/calcite content, both organic content and porosity decrease, resulting in an increase in brittleness. These iso-brittleness lines form a set of parallel curved lines intersecting the matrix-water reference curved line. Brittleness is derived from that graph corresponding to each pair of values of the parameters measured in the well.

### THE OBJECT OF THE INVENTION

The invention is a new method for estimating rock brittleness from data recorded in bore-holes by well-logging tools.

The brittleness is a rock property undergoing sudden rapturing when applied stress reaches some limiting value, with little plastic deformation before rupture. It is measured as Factor of Brittleness or brittleness index (BI). A rock brittleness index depends on elastic properties of the rock as a function of mineralogy of the constituting grains, porosity and grain binding material. The method of the invention focusses on the prediction of brittleness of shales/source rocks by using data obtained from at least three logs of different kinds, a sonic time interval log, a bulk density log and a resistivity log. In the first case, a tool is lowered into a well, containing sound wave transmitting and receiving transducers to measure the time interval of these waves propagating between the transmitter and the transducer through the rocks along the bore-hole penetration. In the second case, it is the density of rocks, whereas in the third case the electric resistivity of the formation surrounding the well is measured.

Estimation of the brittleness of shales and source rocks is a critical element in evaluating the unconventional hydrocarbon potential of a sedimentary basin. Generally, abundant quartz and carbonates content yield high brittleness values, while the high clay content, TOC, and porosity lower the rock brittleness. This invention generally relates to the field of unconventional hydrocarbon exploration, and more particularly to the characterisation of caprock/seal overlying a hydrocarbon (oil, gas, gas-condensates) accumulation and subsurface CO2 storage in sedimentary basins (offshore and onshore) using the well-log data acquired in a borehole.

### BACKGROUND FOR THE INVENTION

Rock brittleness is critical in the development of the unconventional reservoirs, seal characterisation above conventional hydrocarbon accumulation or subsurface CO2 storage. Brittleness is strongly dependent on the lithology as the increase in contents of brittle minerals such as quartz and carbonate increase rock effective brittleness. Conversely, the clay content has a negative influence on the brittleness, even in small weight fractions. Apart from clay, the total organic carbon (TOC) is anticipated to decrease the brittleness as well. Increase in porosity also lowers the brittleness.

Various concepts of brittleness have been proposed in the literature. The BI can be obtained based on the stress-strain ratio, Young's Modulus and Poisson's ratio, energy balance analysis, unconfined compressive strength, Brazilian tensile strength, penetration, impact and hardness test, the mineral composition, porosity analysis, grain size, internal friction angle, the over-consolidation ratio, and geophysical analysis on Lame's parameter and the density. There are various methods of calculating the brittleness index (BI) such as the mineral-based brittleness index (MBI), the log-based brittleness index (LBI), and the elastic-based brittleness index (EBI) (Mews et al. 2019).

The log-based brittleness index calculations are established on linear equations using neutron porosity logs or interval time logs (DTC) (e.g. Jin et al. 2014b), whereas the elasticity based brittleness index have been extracted using interval time logs (both compressional and shear) and bulk density logs (e.g. Jin et al. 2014a; Sun et al. 2013; Sharma and Chopra 2012).

Ogiesoba and Hammes (2014) disclosed a method for the identification of brittleness and TOC-rich shale zones. The method of estimating brittleness involves introducing quality factor “Q value” that directly or indirectly relates total resistivity, TOC, AI and porosity to brittleness. Although the relationship is nonlinear, resistivity and TOC increase as Q increases. High-porosity rocks are more absorptive and are generally characterized by low Q, whereas low-porosity (more compacted, high-velocity) rocks are less absorptive and are characterised by high Q. Additionally, because a strong positive linear relationship exists between AI and Q, Q can be used to identify brittle zones. High Q values which are indicative of less absorptive, or brittle, rocks and correlate with high resistivity values. The determination of the “Q-value”, as given by Ogiesoba and Hammes (2014), is based on a much different formulation than determinations of brittleness as the given in the present method of invention.

Hakami et al. (2016) demonstrated wireline logging methods including spectral gamma ray, sonic, resistivity, resistivity image, density, photoelectric logs, neutron porosity and vertical seismic profile (VSP) for characterisation of carbonate mudrocks for determining shale gas characteristics such as organic matter richness (TOC), clay type and content, intra-kerogen porosity, matrix porosity, brittleness, reservoir pressure, natural fractures, and hydrocarbon saturation. Hakami et al. (2016) estimated the petrophysical parameters including brittleness in shale zones with the aid of generally existing methods, therefore, the present method of invention is a non-obvious solution to the posed problem.

Manriquez et al. (2017) characterised brittleness index using existing relations employing the elastic parameters i.e., Young's modulus and Poisson's ratio (Mews et al. 2019). This method, however, did not use the resistivity data input.

Patent WO63725A1 published in 2000 demonstrated usage of resistivity data to correct an ideal sonic log for departures from the shale sediment assumption. The calculated theoretical sonic log may then be used to calibrate an experimental log and to replace low confidence segments of the experimental logs. This method, however, does not deal with the brittleness index calculations.

Patent CN104564037A published in 2015 employed gamma-ray (GR) log to determine the volume of shale (Vₛₕ). Whereas using photoelectric effect (Pe) data, the siliceous relative content (Vₛᵢ) and the calcareous relative content (V_{ca}) are determined, and finally, the siliceous absolute content Vsi and the calcareous absolute content V_{ca} within the stratum in the research area are determined. The methods estimating mineral fraction from wireline logs, however, do not generally take into account the rock compaction and grain cementation, which define the overall rock mechanical properties.

Patent WO136448A1 published in 2018 describes brittleness index calculations as a part of the method of invention. The procedure involved seismic inversion to obtain acoustic impedance and compressional to shear wave velocity ratio (Vp/Vs), which are then used to calculate Young's modulus and Poisson's ratio. Finally the brittleness index was shown to be obtained using an equation inputting the Young's modulus and Poisson's ratio values. This procedure, however, did not use the resistivity data input. The BI index is dependent on rock lithology and mineralogy. In order to get a universal BI relation, there was a need to use a log-based brittleness index that takes into account, porosity and TOC, constrained by the end-member lithology. Furthermore, the resistivity log has never been used for brittleness prediction in the prior art. Adding resistivity information for brittleness estimation would facilitate taking in to account the influence of organic matter.

### BRIEF SUMMARY

This method of the invention is a mineral-based brittleness index derived from wireline logs. It delivers quality results in a short time, giving a continuous and representative estimation of the brittleness of geological zones employing the data from well logging tools. The method of the invention assumes that the volumetric increase of a brittle mineral either quartz or carbonate results in an increase in overall brittleness of rock to a maximum value 1 fraction. In contrast, an increase in organic matter decreases the overall rock brittleness to a minimum of 0 fraction. The model comprises three poles i.e. matrix (quartz or calcite) pole, organic matter pole and water pole. Iso quartz/calcite-content lines hereby are denoted as iso-brittleness line as with an increase in quartz/calcite content, both organic content and porosity decrease, resulting in an increase in brittleness.

It is characterised in that it comprises: the use of data recorded by at least three well-logging tools measuring three different parameters, selected so that:
a) The product of measurements from tools one and two produce magnitude developing in the same direction in response to a volumetric change in the water, clay and organic matter content in sedimentary rocks,
b) the third tool yields measurement values ending up in opposite directions to each other in response to a volumetric increase in the organic matter content, on the one hand, and the water content, on the other, in the same host-rock, and
c) the three tool data are further selected so that the resulting pairs within the acoustic impedance-resistivity ratio plane correspond to an equal brittleness value, associated respectively with sedimentary rocks comprising a given proportion of rock matrix, TOC, and water, are substantially alike (in a graphic representation, these sets of pairs may be represented by iso-brittleness lines), the plotting of collection of pairs of values corresponding to equal brittleness, so as to obtain a continuous depiction of the brittleness index of the rock zone penetrated by the well.

For example, the signals obtained from at least three well tools are used, adapted for determining the electric resistivity of the rock zone, the velocity of sound and the density through the same formation zone.

In a particular embodiment, measurements made by a well probe are used acquiring the electric resistivity of the ground and the other two tools measuring, for example, the velocity of sound and the density through this same ground, a representation diagram is chosen as a function of the resistivity ratio and of the Acoustic Impedance where said system of pairs of values of the properties measured may be likened to a system of nearly parallel iso-brittleness curves, the brittleness 155 related with each pair of values of the Acoustic Impedance and that of resistivity ratio function acquired in the well then being determined by identifying the brittleness curve passing through the point characteristic of said pair in the selected representative diagram.

The method of the invention has the following advantages compared to the prior art:

The complete and continuous information which it provides inexpensively using the existing wireline log data compared to the expensive prior art geomechanical analysis carried out in the laboratory on a restricted number of samples. Most log-based methods utilise data from one or a maximum of two probes at a time. In contrast, the curved iso-brittleness lines are more accurate representation of the natural iso-content within the acoustic impedance-resistivity ratio domain utilising data from three tools compared to the previous methods (e.g. Jin et al. 2014b; Hakami et al. 2016) which made use of linear functions. In the present invention, the usage of resistivity ratio function on the Y-axis of the AI-resistivity ratio function plane provides a fixed standard template for the analysis; furthermore, it facilitates calibrating the data comprising the matrix with zero percent organic matter content with the matrix-water reference curve to obtain the Rw value.

The flexibility which it provides in terms of the number of input parameters compared to the prior arts as mentioned in Mews et al. (2019) and Ogiesoba and Hammes (2014) makes it usable in a wide range of geological environment.

### BRIEF DESCRIPTION OF THE DRAWINGS

Other features and advantages of the invention will be better understood from the following detailed description and the attached drawings in which:

FIG. 1 illustrates typical wireline log data acquisition for subsurface sonic interval time, rock bulk density and resistivity determination;

FIG. 2 shows a set of iso-brittleness lines and a matrix-water reference curve in a three-pole diagram onto AI—Resistivity ratio plane;

FIG. 3 A-B illustrates the plotting of the set of pairs on the same diagram of values of the parameters acquired in a well by three well-logging probes before the Rw calibration (A), and after Rw calibration (B);

FIG. 4 depicts an example of the graph obtained experimentally, which shows continuous brittleness values obtained by the present method of the invention;

FIG. 5 is a flowchart showing elementary steps in one embodiment of the present inventive method.

### DETAILED EXAMPLES

The method of the invention comprises the use of data acquired by well-logging tools making it possible to separate the influence of ductile organic matter and the brittle mineral matrix such as quartz and carbonates and, thus, to estimate its volume percentage within sedimentary rocks. The increase of volume percentage of a brittle mineral results in a decrease in organic mineral content and overall porosity. So theoretically a brittleness index can be defined with zero fraction value at 100% organic matter pole, and 1 fraction value at 100% quartz/calcite (with zero porosity) pole.

Shales and source rocks usually consist of three components: (1) the rock matrix (clay+quartz/carbonate grains), (2) the Solid organic matter, and (3) the fluid(s) within the pore space (water or oil/gas). Non Source rocks are composed primarily of only two components: the matrix and the fluid filling the pore space. In immature source rocks, organic matter and rock matrix make up the solid fraction, and formation water fills the pore space. As the source rock matures, a part of the solid organic matter is converted to liquid (or gaseous) hydrocarbons that occupy the kerogen/organic matter pore space.

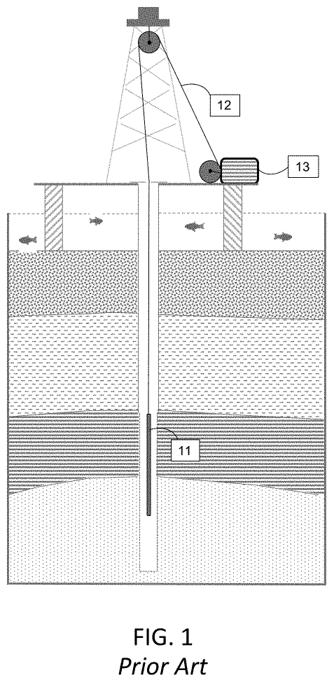

Data obtained from the wellbore may include so-called “well log” data. Such data are typically recorded and presented against depth in the subsurface of various physical parameters measured by probes lowered into the wellbore. Such probes may include, for example, electrical resistivity, acoustic interval time, bulk density, neutron slowing down length, neutron capture cross-section, natural gamma radiation, and nuclear magnetic resonance relaxation time distribution, among others. The well logging procedure comprises a recording of magnitudes of various above mentioned physical properties within a bore-hole using an array of logging probes (FIG. 1, 11), attached with a logging cable (12) connected on the other end to a data recording cabin (13).

The method of the invention contains first of all the selection of three well-logging probes appropriate for predicting the magnitude of organic matter by volume within a rock matrix. The response of well-logging tools is dependent on the properties related to the components as well as their respective percentage in the rocks investigated. The tool measuring the sonic transit time through the formations is sensitive to the water, organic matter and volume of matrix content. The probe measuring the density is sensitive to water and to the organic matter and the void spaces/porosity between the matrix grains. The tool that measures the electric resistivity of the rock makes slight discrimination between the wet clay and the saline water as both are conducting agents, and no discrimination for variations in the composition of the matrix if the conducting minerals are not in a continuous phase. The product of density with sonic derived velocity is called acoustic impedance. We used acoustic impedance values as a combined augmented response of the sonic and density probes within the method of the invention. A function namely resistivity ratio function was introduced within the method of the invention. The resistivity ratio function was defined as the square root of the ratio between the resistivity of Formation water and the total resistivity measured by the resistivity tool.

In the shale containing low organic matter content, the two curves, i.e. acoustic impedance and resistivity ratio, respond to rock porosity. But in organic-rich shales both the acoustic impedance and resistivity curves respond due to two main effects: 1) the acoustic impedance curve responds to the presence of low-density low-velocity kerogen, and 2) the resistivity ratio curve responds to the porosity and formation fluid. When maturity in a high-TOC shales/source rocks is low and no hydrocarbons have been generated, both the acoustic impedance and resistivity ratio response is caused only by the porosity response to low density and/or low-velocity TOC. Conversely, when maturity is high in such organic-rich rocks, the resistivity response increases due to the generated hydrocarbons. Since the generated hydrocarbon stays within the pores of organic matter, assumption to include this hydrocarbon volume with the organic matter, and considering the porosity equal to the volume only filled by water simplifies the process of isolating the organic matter volume. In an organic-rich rock, 100% matrix content with zero porosity, or 100% organic matter with zero porosity is assumed to yield infinity resistivity, resulting in zero resistivity ratio values. On the other hand at water pole, the resistivity of water (R_{w}) theoretically becomes equal to the total resistivity (Rₜ) resulting in a resistivity ratio value of 1.

The two properties obtained from the well log data are chosen also so that the collection of pairs of values of acquired parameters (namely the acoustic impedance on the one hand and the resistivity ratio function on the other) at least partly correspond to the equal quartz/calcite content volume for sedimentary rocks comprising a given proportion of organic matter or water are substantially identical.

This selection of petrophysical parameters substantially simplifies the operation for estimating the brittleness. In a cross-plot of the two chosen properties, the collection of pairs of values of the said parameters are spread over iso-quartz/calcite content curves, which are akin to brittleness curves. A diagram may be drawn where the iso-brittleness curved lines represent various matrix-organic matter ratio.

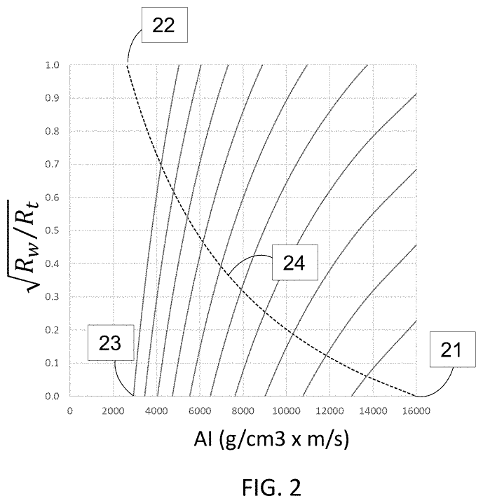

The baseline represented by the X-axis along the resistivity ratio function (\sqrt{R_{w}/Rₜ})=0 was assumed to be having infinity resistivity and zero porosity. If we assume the rock consists of quartz or calcite matrix at one extreme (FIG. 2, 21), organic matter (OM) at another extreme (23), and water-filling the matrix porosity then collection of pairs of values of the parameters serving as reference which is represented by the iso-quartz/calcite curved line equivalent to a given matrix percentage within a rock obtained experimentally from values of the two chosen parameters acquired along a well. In the diagram as a function of AI and \sqrt{R_{w}/Rₜ} this reference line is either the curved reference line with 0% quartz/calcite content volume or zero brittleness line extending from the 100% organic matter pole (23) to which 0 fraction brittleness may be attributed.

This method of determining the R_{w} to align the water-bearing matrix with 0% organic matter data points along the water-matrix reference line (24) implies that, among the zones crossed by the well, some is devoid of organic matter. This is possible if we assume the data pairs with the lowest resistivity ratio function values occasionally showing a trend partly parallel to the water-matrix reference line. It is also possible to verify the existence of such zones by comparison with geochemical and other petrophysical analysis results within a basin.

The water-matrix reference line that joins the 100% (or 1 fraction) matrix (21) with the water pole (22), is obtained by applying the relation:

$$\sqrt{\frac{{R}_{w}}{{R}_{t}}} = \frac{{ρ}_{ma} - \frac{AI}{{Vp}_{ma}}}{\sqrt{a} [ AI ( \frac{1}{{Vp}_{w}} - \frac{1}{{Vp}_{ma}} ) - ( {ρ}_{w} - {ρ}_{ma} ) ]} \qquad ( 1 )$$

where V_{Pma} and V_{Pw} are the P-wave velocities of the mineral matrix and the pore fluid (water) respectively, ρₘₐ is density of mineral grains, ρ_{w} is density of pore fluids that is water in this case, Rₜ is deep resistivity, R_{w} is the resistivity of water, ‘a’ is tortuosity factor and AI is acoustic impedance. The tortuosity factor ‘a’ controls the slope of the water-matrix curved line and may be selected in a formation zone depending on pore structure, grain size and level of compaction. The relevant constants may be taken from Mavko et al (2009) and vendors' logging chart books.

From the following function (equation 2) we are able to define a set of lines corresponding to brittleness from 0 to 1 fraction in the Acoustic impedance-resistivity ratio function plane (FIG. 2)

$$\sqrt{\frac{{R}_{w}}{{R}_{f}}} = \frac{\frac{A I}{{Vp}_{om}} {ρ}_{o m} - BI [ ( {ρ}_{m a} - {ρ}_{o m} ) - AI ( \frac{1}{{Vp}_{ma}} - \frac{1}{{Vp}_{om}} ) ]}{\sqrt{a} [ AI ( \frac{1}{{Vp}_{w}} - \frac{1}{{Vp}_{om}} ) - ( {ρ}_{w} - {ρ}_{o m} ) ]} \qquad ( 2 )$$

where Vₚₒₘ is the P-wave velocities of the organic matter (OM), ρₒₘ is the density of organic matter and BI is the brittleness index in fraction. Rearranging the equation, brittleness can be calculated in fraction using the following equation:

$$BI = \frac{\frac{A I}{{Vp}_{om}} - {ρ}_{o m} - \sqrt{\frac{{aR}_{w}}{{R}_{t}}} [ AI ( \frac{1}{{Vp}_{w}} - \frac{1}{{Vp}_{om}} ) - ( {ρ}_{w} - {ρ}_{om} ) ]}{[ ( {ρ}_{ma} - {ρ}_{om} ) - AI ( \frac{1}{{Vp}_{ma}} - \frac{1}{{Vp}_{om}} ) ]} \qquad ( 3 )$$

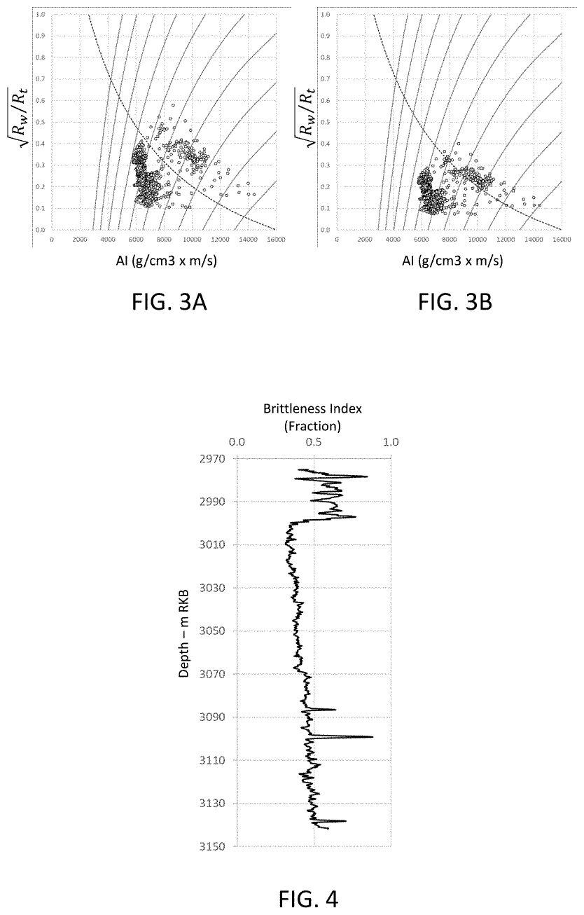

The data is plotted using some initial value of R_{w} and still, the Rw is unknown. Iterate the value of R_{w} making the upper right part of the data representing the matrix to fall on the matrix-water with 0% OM reference line (FIGS. 3A&B). This obtained Rw is not the actual resistivity of water, but rather is apparent R_{w} that compensates for the deviation from initial assumptions since the actual rock consists of water, clay, matrix, possible hydrocarbon in pores, and OM. The rock's resistivity responds to a more complex function depending on the porosity, R_{w}, the volume of shale (Vₛₕ) and resistivity of shale (Rₛₕ) (Bessereau et al. 1991). Finally inputting the 325 value of Rw in equation 3, calculate the brittleness index (BI) as a continuous property along the penetrated depth (FIG. 4).

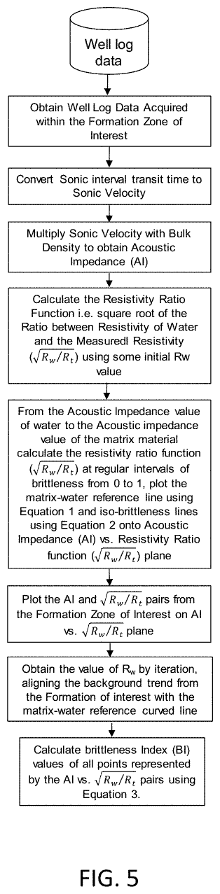

The procedure workflow which is followed so as to obtain the plot of the brittleness against depth is shown in FIG. 5.

In the case where geochemical analysis is available from the well, a comparison may be made between it and the logging data to obtain an average value of the resistivity of formation water ‘R_{w}’ and subsequently the tortuosity factor 335 ‘a’ to apply on the data from other wells.

The resistivity of water (R_{w}) and tortuosity factor (a), which are functions of rock depositional environment, mineralogy, organic matter type, and maturity may vary in nature within the same area. A stochastic approach employing Monte Carlo 340 simulations can be utilised to take into account the resultant TOC uncertainty. The input values of Rw, and a, in this case, will be fed randomly in the form of normal, or other suitable distributions.

The technical solution is only one embodiment of the present invention, to those skilled in the art, the present invention discloses a basic principle of the method and applications, very easy to make various types of modifications or variations, the method is not limited to the specific embodiments of the present invention described above, and therefore the manner described above are only preferred and is not in a limiting sense.

### REFERENCES CITED

PATENT DOCUMENTS

| | | |
|---|---|---|
| WO 63725A1 | October 2000 | Michael John Wiltshire |
| CN 104564037A | April 2015 | Shi Qiang, Chen |

| | |
|---|---|
| i. | Peng, Xiao Yufeng, Zeng |
| | Qingcai, |
| ii. | Liu Fengxin and Zhiyu Wang |
| iii. | Shuyin |

| | | |
|---|---|---|
| WO 136448A1 | July 2018 | Shubham Mishra |

### PUBLICATIONS

Bessereau, G., B. Carpentier & A. Y. Huc (1991): “Wireline Logging And Source Rocks-Estimation Of Organic Carbon Content By The Carbolog Method”, Log Anal., 32, 03.
Hakami, A., A. Al-Mubarak, K. Al-Ramadan, C. Kurison & I. Leyva (2016): “Characterization of carbonate mudrocks of the Jurassic Tuwaiq Mountain Formation, Jafurah basin, Saudi Arabia: Implications for unconventional reservoir potential evaluation”, Journal of Natural Gas Science and Engineering, 33, 1149-1168.
Jin, X., S. N. Shah, J.-C. Roegiers & B. Zhang (2014a): “Fracability evaluation in shale reservoirs—an integrated petrophysics and geomechanics approach”, in: Fracability evaluation in shale reservoirs—an integrated petrophysics and geomechanics approach 2014.
Jin, X., S. N. Shah, J. A. Truax & J.-C. Roegiers (2014b): “A practical petrophysical approach for brittleness prediction from porosity and sonic logging in shale reservoirs”, in: A practical petrophysical approach for brittleness prediction from porosity and sonic logging in shale reservoirs 2014.
Manriquez, A. L., K. Sepehrnoori & A. Cortes (2017): “A novel approach to quantify reservoir pressure along the horizontal section and to optimize multistage treatments and spacing between hydraulic fractures”, Journal of Petroleum Science and Engineering, 149, 579-590.
Mavko, G., T. Mukerji & J. Dvorkin (2009): The rock physics handbook: Tools for seismic analysis of porous media, Cambridge university press.
Mews, K. S., M. M. Alhubail & R. G. Barati (2019): “A Review of Brittleness Index Correlations for Unconventional Tight and Ultra-Tight Reservoirs”, Geosciences, 9, 7, 319.
Ogiesoba, O. & U. Hammes (2014): “Seismic-attribute identification of brittle and TOC-rich zones within the Eagle Ford Shale, Dimmit County, South Texas”, Journal of Petroleum Exploration and Production Technology, 4(2), 133-151.
Sharma, R. K. & S. Chopra (2012): “New attribute for determination of lithology and brittleness”, in: SEG Technical Program Expanded Abstracts 2012 2012, 1-5.
Sun, S. Z., K. N. Wang, P. Yang, X. G. Li, J. X. Sun, B. H. Liu & K. Jin (2013): “Integrated prediction of shale oil reservoir using pre-stack algorithms for brittleness and fracture detection”, in: Integrated prediction of shale oil reservoir using pre-stack algorithms for brittleness and fracture detection 2013.

The invention claimed is:

1. A method for quantifying the brittleness index of shales within a sedimentary basin using well-logging data measured in a well, comprising:
using data provided by at least three well-logging probes measuring three different parameters, selected so that:
a) The product of the velocity of sound obtained from one tool with the density data obtained from the second tool, hereby called acoustic impedance develop in the same direction in response to a volumetric change of the water, clay and organic matter content in the said sedimentary rocks,
characterised by
b) the third probe produces measurement signals hereby modified to a resistivity ratio function developing in opposite directions to each other due to the organic matter content variation, on the one hand, and the water content, on the other, in the same sedimentary rocks, and
c) the three probes being further selected so that the resulting pairs within the acoustic impedance-resistivity ratio plane correspond to an equal brittleness, associated respectively with the said rocks comprising a given percentage of organic matter, rock matrix and water, are equal represented by one pair of values of the representative parameters of the pure organic matter, creating a system of sets of pairs of values of the acquired parameters, to obtain a continuous representation of the brittleness of the formations penetrated by the well,
using equation
$$d ) BI = \frac{\frac{A I}{{Vp}_{om}} - {ρ}_{o m} - \sqrt{\frac{{aR}_{w}}{{R}_{t}}} [ AI ( \frac{1}{{Vp}_{w}} - \frac{1}{{Vp}_{om}} ) - ( {ρ}_{w} - {ρ}_{om} ) ]}{[ ( {ρ}_{ma} - {ρ}_{om} ) - AI ( \frac{1}{{Vp}_{ma}} - \frac{1}{{Vp}_{om}} ) ]}$$
where Vₚₘₐ, Vₚₒₘ, and V_{pw} are the P-wave velocities of the mineral matrix, organic matter (OM), and the pore fluid (water) respectively, ρₘₐ is density of mineral grains, porn is the density of organic matter, ρ_{w} is density water, Rₜ is deep resistivity, R_{w} is the resistivity of water, ‘a’ is tortuosity factor, AI is acoustic impedance, and BI is the brittleness index in fraction.

2. The method of claim 1, wherein the measurements made by at least three well probes are employed, adapted for measuring the electric resistivity of the formation penetrated, the transit time of sound through the same ground, and the density of the said ground.

3. The method as claimed in claim 2, a resistivity ratio function is defined as the square root of the ratio between the resistivity of water and the total resistivity values obtained from the resistivity probe.

4. The method of claim 2, wherein measurements made by a well probe measuring the electric resistivity of the zone in the sub-surface and two other well probes measuring the transit time of sound and the density through this same zone, a representation diagram is chosen as a function of the resistivity ratio function and of the acoustic impedance where said system of sets of pairs of values of the parameters acquired, each associated with the same content, may be likened to a set of parallel iso-brittleness curves, the brittleness associated with each pair of values of the acoustic impedance and of the resistivity ratio measured in the well then being determined by identifying the iso-brittleness curve passing through the point representative of said pair in the chosen representation diagram.

5. The method of claim 2, wherein the slope of the matrix-water curve is controlled by the tortuosity factor ‘a’ that is selected for a formation zone considering the pore structure, grain size and level of compaction.

6. The method of claim 2, wherein the resistivity of water is determined by iterating the resistivity of water while aligning the 100% water-saturated well data onto the acoustic impedance-resistivity ratio plane with the matrix-water reference curved line.

7. The method of claim 2, wherein measurements are used made by a well probe measuring the electric resistivity of the ground, and two other probes, one measuring the speed of sound within the ground and the other density.

8. The method of claim 1, wherein quantities from each pair of the parameters acquired in the well is demonstrated in a diagram as a function of coordinates, one measuring acoustic impedance in the rock and the other the square root of the ratio between the resistivity of water and the resistivity of rock, hereby called the resistivity ratio function, where the collection of pairs of values equivalent to a corresponding brittleness are manifested by a system of curved lines to which a given brittleness may be allocated, intersecting a reference curved line representing water-bearing matrix with zero fraction organic volume content.

9. The method of claim 9, wherein the positions of the iso-brittleness curved lines are determined between an axis with the 100% rock matrix member on one end and the 100% organic matter on the other end, both represented by the values taken by the two parameters.

10. The method of claim 1, wherein the pair of values typical of the pure organic matter, pure matrix and water are obtained from the existing literature.

11. The method of claim 1, wherein to obtain stochastic brittleness results, the distribution of input parameters comprising resistivity of water and tortuosity factor are to be fed in random fashion performing calculations using Monte-Carlo simulation.
